(19) United States
(12) Patent Application Publication
(10) Pub. No.: US 2026/0323283 A1
(43) Pub. Date: Oct. 15, 2026

(54) PROVIDING BACKWARD COMPATIBILITY FOR AUTHENTICATION PROTOCOLS SPECIFIED BY USER DEVICES

(71) Applicant: HEWLETT PACKARD ENTERPRISE DEVELOPMENT LP, Spring, TX (US)

(72) Inventor: Riccardo Manfrin, Selvazzano Dentro (IT)

(21) Appl. No.: 19/176,546

(22) Filed: Apr. 11, 2025

(51) Int. Cl. H04W 12/06; H04W 12/041; H04W 12/30

(52) U.S. Cl. CPC H04W 12/06; H04W 12/041; H04W 12/30

(57) ABSTRACT

A technique includes, determining a given authentication method, or protocol, specified by a user device. The technique includes receiving, from a wireless access point device, an access request corresponding to the user device. The access request includes data representing an identity associated with the user device. The technique includes, responsive to receiving the access request, providing backward compatibility for the given authentication protocol. Providing the backward compatibility includes providing, to a mobile network-based authentication server, a second request that includes data representing the identity and includes data representing the given authentication protocol. The mobile network-based authentication server is associated with a mobile network authentication services standard, and the given authentication protocol is not associated with the mobile network authentication services standard.

### BACKGROUND

A wireless local area network (WLAN)-capable user device may connect to a wireless access point device for purposes of accessing a network. When the user device first connects to the access point device, the user device and the access point device exchange packets, or frames, as part of a process to onboard the user device.

### BRIEF DESCRIPTION OF THE DRAWINGS

FIG. 1 is a block diagram of an Extensible Authentication Protocol (EAP) framework, which includes an EAP authentication method convergence-capable proxy server that accommodates current and prior generation mobile network-based EAP authentication methods, according to an example implementation.

FIGS. 2A and 2B depict an authentication message flow that uses an EAP authentication method convergence solution, according to an example implementation.

FIG. 3 depicts a sequence flow illustrating a mobile network-based authentication server's integration into an EAP authentication method convergence solution, according to an example implementation.

FIG. 4 is a flow diagram depicting a technique to provide backward compatibility for an authentication protocol specified by a user device, according to an example implementation.

FIG. 5 is a block diagram of a system having a mobile network-based authentication server that generates an authentication vector having a value that is not defined by an authentication services standard associated with the authentication server, according to an example implementation.

FIG. 6 is an illustration of a storage medium that stores hardware processor-readable instructions that, when executed by a hardware processor, cause a proxy server to send an authentication information object to a mobile network-based authentication server to cause the server to apply a non-mobile network authentication method that is not defined by an authentication services standard associated with the authentication server, according to an example implementation.

### DETAILED DESCRIPTION

A WLAN access point device (called a "wireless access point device" herein) may function as an authenticator, or gatekeeper, to control access to a WLAN that is created by the device. A WLAN-capable user device (called a "wireless user device" herein), by successfully undergoing an onboarding process, gains access to the WLAN and possibly gains access, through the wireless access point device, to a larger network infrastructure, such as a local area network (LAN), or a wide area network (WAN).

As part of an onboarding process, a wireless user device exchanges packets, or frames, with a wireless access point device. The exchange of frames, in addition to achieving other results, allows the wireless user device to associate with the wireless access point device, informs the wireless access point device of the user device's capabilities and provides identifying information to the wireless access point device. The exchange of frames during onboarding further provides information that allows the wireless user device and the wireless access point device to mutually authenticate each other. In this context, "authentication" of a first entity by a second entity generally refers to verification, by the second entity, of the first entity's identity. The exchange of frames during onboarding also provides information (assuming successful mutual authentication) that allows the wireless user device and the wireless access point device to independently generate session keys that protect data communications between the wireless user device and the wireless access point device.

A business entity may have an enterprise network that includes one or multiple WLAN access networks that adhere to the Institute of Electrical and Electronics Engineers (IEEE) 802.11 family of standards for WLANs, commonly referred to as "WiFi." The WLAN access networks of the enterprise network may comply with a WiFi security protocol that is designed for a business environment, such as a Wireless Protected Access 2-Enterprise (or "WPA2-Enterprise") security protocol. The WPA2-Enterprise security protocol is described in the IEEE 802.1X-2020 standard (herein called the "IEEE 802.1X standard") entitled, "IEEE Standard for Local and Metropolitan Area Networks--Port-Based Network Access Control," and which published on February 28, 2020. The IEEE 802.1X standard defines the encapsulation of an Extensible Authentication Protocol (EAP) over WLANs and LANs.

An EAP framework includes an authentication server and one or multiple access point devices, such as wireless access point devices. A wireless access point device serves as an authenticator, or gatekeeper, to control access to a network. Based on identifying information provided by a wireless user device and other information (e.g., a proof, such as a value provided by the wireless user device in response to an authentication challenge), the authentication server verifies the identity of the wireless user device. If the authentication server's verification of the wireless user device's identity is successful, then the wireless access point device allows the wireless user device to access the network. Otherwise, the wireless access point device denies the wireless user device from accessing the network. The wireless user device may use information provided by the network to authenticate the network and therefore, disassociate from the wireless access point device should the wireless user's device authentication of the network fail.

An enterprise network may use one of a number of EAP authentication methods (also called "EAP authentication protocols," "authentication methods," or "authentication protocols" herein). For a user device that is equipped with a mobile network radio (or "cellular radio") and is therefore, mobile network-capable, an EAP framework may rely on a mobile network-based authentication server and leverage use of the wireless user device's subscriber identity module (herein called the "identity module"). In an example, the identity module may be a physical subscriber identity module, or "SIM," and in another example, the identity module may be an embedded SIM, or "eSIM." One type of EAP authentication method (also referred to as a "shared secret-based EAP authentication method" herein) may rely on a shared secret. The shared secret may either be directly represented by data stored in the identity module or be derived from data that is stored in the identity module. In an example, a shared secret may be a cryptographic hash that is derived from data (e.g., data representing an International Mobile Subscriber Identity (IMSI)) that is stored in the identity module. The secret is "shared" in that the secret is known to the wireless user device and the authentication server.

The EAP framework includes a proxy server that communicates, on behalf of the enterprise network, with the mobile network-based authentication server. The proxy server functions as a communication bridge to translate between an authentication and authorization messaging protocol that is used by the wireless access point device and an application programming interface (API)-based communication protocol that is used by the mobile network-based authentication server.

In one approach, a mobile network-based authentication server is affiliated with a particular shared secret-based EAP authentication method. In an example, for a fourth generation (or "4G") mobile network, an authentication server (called a "4G authentication server" herein) may be limited to using an EAP-Authentication and Key Agreement (or "EAP-AKA") authentication method for shared secret-based EAP authentication. In another example, for fifth generation (5G) mobile networks, the EAP-AKA authentication method has been replaced with an EAP-AKA' (or "EAP-AKA prime") authentication method. Unlike the EAP-AKA authentication method, the EAP-AKA' authentication method binds generated session keys to an access network name. Due to the replacement of the EAP-AKA authentication method with the EAP-AKA' authentication method, 5G mobile network-based authentication servers (herein called "5G authentication servers") do not support the replaced EAP-AKA authentication method.

A user device may be configured (e.g., configured by an option that is part of the user device's WPA2-Enterprise profile) to specify a particular EAP authentication method that is to be used for WPA2-Enterprise authentication. The specified EAP authentication method is independent from the available mobile network(s) and may be downgraded from the full mobile network capabilities of the user device. It is not uncommon for a 5G-capable wireless user device to specify an EAP-AKA authentication method (instead of the EAP-AKA' authentication method that is defined by the 5G authentication services standard). Because a given wireless device may specify an EAP authentication method that is available either on a 4G authentication server or a 5G authentication server, an EAP framework’s proxy server, in one approach, is constructed to accommodate either selection. In this manner, in one approach, a proxy server for an EAP framework has both a 4G mobile network interface (to communicate with a 4G authentication server) and a 5G mobile network interface (to communicate with a 5G authentication server). For a user device that specifies an EAP-AKA authentication method, the proxy server, using its 4G mobile network interface, calls a 4G network authentication function that is served by a 4G authentication server. For a user device that specifies an EAP-AKA' authentication method, the proxy server, using its 5G mobile network interface, calls a 5G authentication function that is served by a 5G authentication server.

An EAP framework supporting both 4G and 5G mobile network interfaces may face certain challenges. For example, the communication protocol (e.g., a Diameter protocol) that is used by the proxy server to communicate with a 4G authentication server is different from the communication protocol (e.g., a Service Based Interface (SBI) protocol) that is used by the proxy server to communicate with a 5G authentication server. Accordingly, supporting both 4G and 5G mobile network interfaces complicates the enterprise network's part of the EAP framework. Another challenge related to supporting both 4G and 5G mobile network interfaces is that on the mobile network side, information for the user device may be unavailable. A 4G authentication server relies on a Home Subscriber Server (HSS), whereas a 5G authentication server relies on a user identity management (UDM) database. It is possible that a wireless user device may attempt to wirelessly connect to a WPA2-Enterprise-based network at a geographical location for which the serving mobile network does not allow the authentication server (e.g., a 4G authentication server) to access the appropriate user database (e.g., an HSS).

In accordance with example implementations that are described herein, an EAP framework for an enterprise network relies on a single authentication server (e.g., a 5G authentication server) to handle both EAP-AKA and EAP-AKA' authentication methods. By virtue of a single authentication server handling both EAP-AKA and EAP-AKA authentication methods, the design of the enterprise network's proxy server is simplified. Moreover, the use of a single authentication server corresponds to the use of a single database (e.g., a UDM database) to retrieve user device identifying information. Therefore, by using a 5G authentication server (as an example), the EAP-AKA authentication method may be used and does not depend on the availability of a 4G HSS.

The EAP framework, in accordance with example implementations, includes a 5G authentication server and an authentication method convergence-capable proxy server (called the "proxy server" herein). The 5G authentication services standard defines an API for accessing an authentication function that is served by a 5G authentication server. More specifically, an API call to the 5G authentication function passes an authentication information object (e.g., a JavaScript Object Notation (JSON) object) that defines properties of the requested authentication. The 5G authentication services standard defines an authentication type as being one of the authentication information object's properties. In the schema definitions for the authentication information object, the 5G authentication services standard defines an enumerated string type and lists specific enumerated strings (e.g., "5G_AKA," "EAP_AKA_PRIME," "EAP_TLS" and "EAP_TTLS") for the enumerated string type. The enumerated strings correspond to respective authentication methods that are supported, or associated with, the 5G authentication services standard. As the EAP-AKA authentication method is replaced by the EAP-AKA' authentication method in the 5G authentication services standard, the EAP-AKA authentication method is not supported by, or associated with, the 5G authentication services standard. Accordingly, the 5G authentication services standard does not define an enumerated string for the EAP-AKA authentication method, such as "EAP_AKA" (or a variation thereof).

In accordance with example implementations that are described herein, the proxy server takes advantage of a feature of the 5G authentication services standard's schema definitions for the authentication information object for purposes of notifying a 5G authentication server to use the EAP-AKA authentication method. More specifically, in accordance with example implementations, the schema definitions define a non-enumerated, generic string type for the authentication type (in addition to defining the enumerated string type). The proxy server is constructed to use a string corresponding to a non-enumerated string type to notify a 5G authentication server when to use the EAP-AKA authentication method. In this manner, responsive to a wireless user device specifying use of the EAP-AKA authentication method, the proxy server includes, as an authentication type in the authentication object, a particular non-enumerated string (e.g., EAP_AKA) to inform the 5G authentication server to use the EAP-AKA authentication method. In accordance with example implementations, the proxy server is further constructed to, in response to a wireless user device specifying use of the EAP-AKA' authentication method, use the standard's supported "EAP_AKA_PRIME" enumerated string to notify the 5G authentication server to use the EAP-AKA' authentication method.

Among the potential advantages of the EAP authentication convergence solution that is described herein, the solution provides backward capability so that a user device-specified EAP-AKA authentication method can be applied by a 5G authentication server, even though the 5G authentication services standard is not associated with the EAP-AKA authentication method. Another benefit of the EAP authentication convergence solution that is described herein is that the proxy server has a single mobile network interface, which simplifies the proxy server's design. Another benefit is that the EAP authentication convergence solution provides backward compatibility in a way that complies with and therefore, does not modify, the 5G authentication services standard.

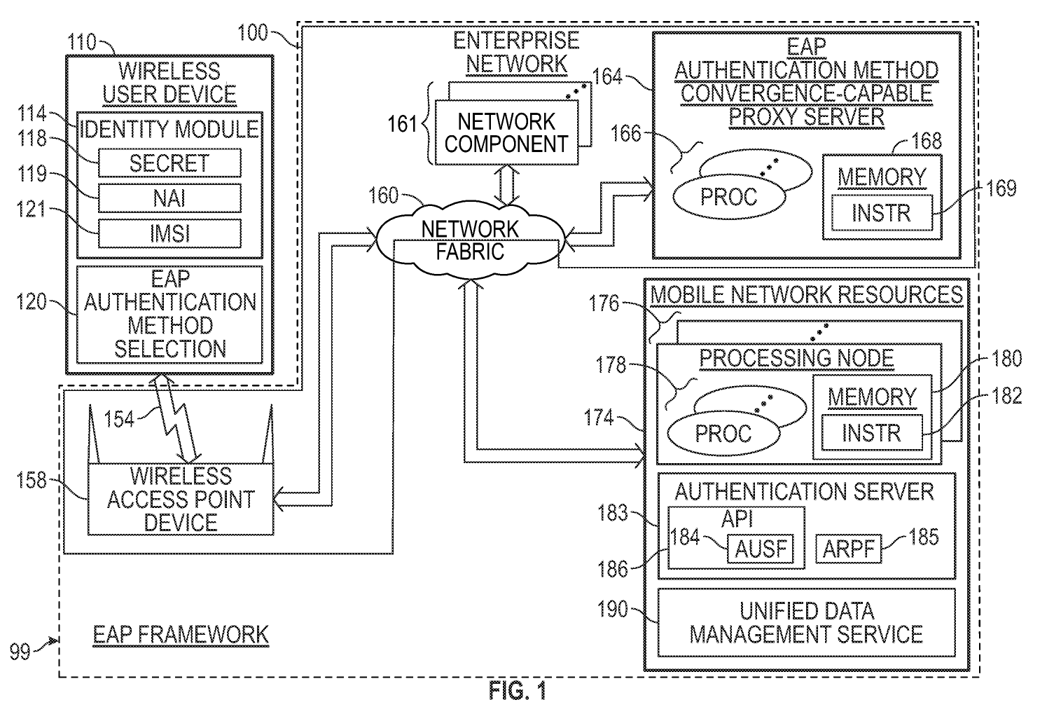

Referring to FIG. 1, as a more specific example, in accordance with some implementations, an EAP framework 99 regulates WLAN access, by WLAN and mobile network-capable user devices (also called "user devices," "user equipment, "client stations," "mobile stations," "mobile devices," "supplicants," or "supplicant devices"), to an enterprise network 100. FIG. 1 depicts an example user device 110 (called the "wireless user device 110" herein), which has WLAN and mobile network radios that allow the wireless user device 110 to wirelessly connect to and communicate with both WLANs and mobile networks. FIG. 1 depicts the wireless user device 110 being connected to a wireless access point device 158 of the enterprise network 100 by a WLAN link 154.

The wireless user device 110 includes an identity module 114 (e.g., a physical SIM or an eSIM) that stores data representing identifying information that is associated with a mobile network-subscribing user of the wireless user device 110. In an example, the identifying information includes data that represents a network access identity (NAI) 119 (e.g., a network domain affiliated with the enterprise network 100, such as "@CompanyABC.com"). In another example, the identifying information includes data representing an International Mobile Subscriber Identifier (IMSI) 121.

The EAP framework 99 includes an authentication server 183 (e.g., a 5G authentication server) that is hosted by mobile network resources 174. The authentication server 183, in accordance with example implementations, is constructed to perform authentication and key agreement services to regulate network access of wireless user devices, such as the wireless user device 110. For this purpose, the identity module 114 of the wireless user device 110, in accordance with example implementations, stores data that corresponds to an authentication secret 118 that is shared with the authentication server 183.

In an example, the authentication secret 118 is a cryptographic hash or cryptographic key that is directly represented by data that is stored in the identity module 114. On the mobile network side, the authentication server 183 retrieves the authentication secret from a UDM service 190 based on, for example, the wireless user device's IMSI 121. In another example, the authentication secret 118 is not directly represented by data that is stored in the identity module 114, but instead, the authentication secret 118 is a cryptographic hash (e.g., a keyed cryptographic hash of the IMSI 121) that is derived from data stored in the identity module 114. On the mobile network side, the authentication server 183 applies the same cryptographic hash for purposes of deriving the authentication secret 118.

In addition to storing data, in accordance with example implementations, the identity module 114 is constructed to perform operations related to the onboarding of the wireless user device 110. In another example, the operations include actions to communicate EAP frames with a wireless access point device 158. In an example, these operations include operations corresponding to algorithms for performing an EAP authentication method.

The wireless user device 110 is configured to specify a particular EAP authentication method (i.e., a particular EAP authentication method to be used by the wireless user device 110 and to be used by an authentication server). In an example, a specified EAP authentication method corresponds to a user-selectable WPA2-Enterprise option (e.g., selected via input provided by a user) that forms part of the wireless user device's WPA2-Enterprise profile. In another example, a manufacturer of the wireless user device 110 configures the wireless user device 110 to specify a particular EAP authentication method. In another example, a mobile network operator (MNO) associated with the wireless user device 110 configures the wireless user device 110 to specify a particular EAP authentication method. Regardless of how the wireless user device 110 is configured to specify its EAP authentication method, in accordance with example implementations, the wireless user device 110 stores data 120 representing the specified EAP authentication method.

In accordance with example implantations that are described herein, the specified EAP authentication method is a shared secret-based EAP authentication method, such as the EAP-AKA authentication method or the EAP-AKA' authentication method. A shared secret-based EAP authentication method is to be contrasted to as opposed to certificate-based EAP authentication methods (e.g., EAP-TLS or EAP-TTLS authentication methods), which rely on digital certificates being stored on user devices. The EAP-AKA authentication method is described in Request for Comments (RFC) No. 4187, entitled, "Extensible Authentication Protocol Method for 3rd Generation Authentication and Key Agreement (EAP-AKA)," published by the Network Working Group (January 2006). The EAP-AKA' authentication method is described in RFC No. 5448, entitled, "Improved Extensible Authentication Protocol Method for 3rd Generation Authentication and Key Agreement (EAP-AKA')," published by the Network Working Group (May 2009).

In addition to the authentication server 183, the EAP framework 99 includes components of the enterprise network 100, including an EAP authentication method convergence-capable proxy server (called the "proxy server 164" herein) and one or multiple wireless access point devices 158. A wireless access point device 158 serves as an authenticator, or gatekeeper, to control whether or not associated wireless user devices, such as the wireless user device 110, may connect to a WLAN, an access network, which is created by the wireless access point device 158. The wireless access point device 158, dependent on the access rights of the wireless user devices, may also control access of the user devices to a larger network infrastructure (e.g., one or multiple LANs of the enterprise network 100, a WAN, and so forth) behind the wireless access point device 158.

For purposes of onboarding WLAN-capable user devices, such as the wireless user device 110, the wireless access point device 158 and the WLAN-capable user devices wirelessly communicate packets, or frames, according to an EAP over LAN, or "EAPoL," protocol. In accordance with example implementations, the proxy server 164 and the wireless access point device 158 communicate with each other using a messaging protocol that is described in RFC No. 2865, entitled, "Remote Authentication Dial In Service (RADIUS)," and published by the Network Working Group (June 2000). The proxy server 164 may be generally characterized as being a RADIUS server, whose authentication and authorization functions have been offloaded to the authentication server 183.

In accordance with example implementations, the mobile network resources 174 correspond to a 5G telecommunications system, as defined by the technical specifications standards that are set forth by the 3rd Generation Partnership Project (3GPP). The mobile network resources 174 are part of a 5G mobile network core and are affiliated with a particular MNO. The enterprise network 100 is not defined by 3GPP standards and is not associated with an MNO. From the perspective of the mobile network, the enterprise network 100 may be considered an untrusted 3GPP network, as the enterprise network 100 is not under the control of the mobile network's MNO. The authentication server 183 provides 3GPP authentication and authorization services to regulate non-3GPP network access by wireless user devices, such as the wireless user device 110.

In accordance with example implementations, the authentication server 183 provides authentication services that are defined by what is referred to herein as a "5G Authentication Services Standard," such as Release 18 of 3GPP Technical Specification (TS) 29.509 entitled, "Authentication Server Services," Version 18.5.0 (June 2024), published in the United States by Alliance for Telecommunications Industry Solutions (ATIS),or variants thereof (e.g., prior or future versions of Release 18). Moreover, as described herein, in accordance with example implementations, the authentication server 183, in addition to providing the authentication services that are defined by the 5G Authentication Services Standard, such as providing operations corresponding to the algorithms to perform the EAP-AKA authentication method. Because the EAP authentication method is associated with controlling access to a non-3GPP network that does not comply with 3GPP standards, the EAP authentication method may be referred to as being a non-3GPP authentication method, or alternatively, may be referred to as being a "non-mobile network authentication method."

The authentication server 183, in accordance with example implementations, provides, or serves, a front-end, authentication server function 184 (called the "AUSF 184" herein) for purposes of providing, among other services, authentication and authorization services to regulate non-3GPP access, such as regulating WLAN access to an enterprise network (e.g., the enterprise network 100). As further described herein, the proxy server 164 communicates with the AUSF 184 using an API 186 that is provided by the authentication server 183. In accordance with example implementations, in addition to serving the AUSF 184, the authentication server 183 also serves a back-end, Authentication Credential and Repository Function 185 (called the "ARPF 185" herein). In accordance with example implementations, the ARPF 185 may be called by the AUSF 184 to generate authentication vector values that comply with the particular EAP authentication methods that are specified by user devices.

In the context that is used herein, an application programming interface, or "API," refers to a collection of software components that establish a relationship between inputs and outputs. For this purpose, the software components collectively provide one or multiple functions, operations or actions. As described herein, an API request (or "API call") is an input provided by a requestor (such as the proxy server 164) and is directed to invoking one or multiple functions, operations or actions of a particular API for purposes of producing one or multiple outputs. In response to a particular API request, an API may provide an output, called an "API response," which the API sends back to the requestor. In an example, the AUSF 184 provides a Service Based Interface (SBI); and API requests and API responses that are similar to the Representational State Transfer (REST) protocol are communicated between the proxy server 164 and the authentication server 183 using Hypertext Transfer Protocol 2 (or "HTTP/2") messaging.

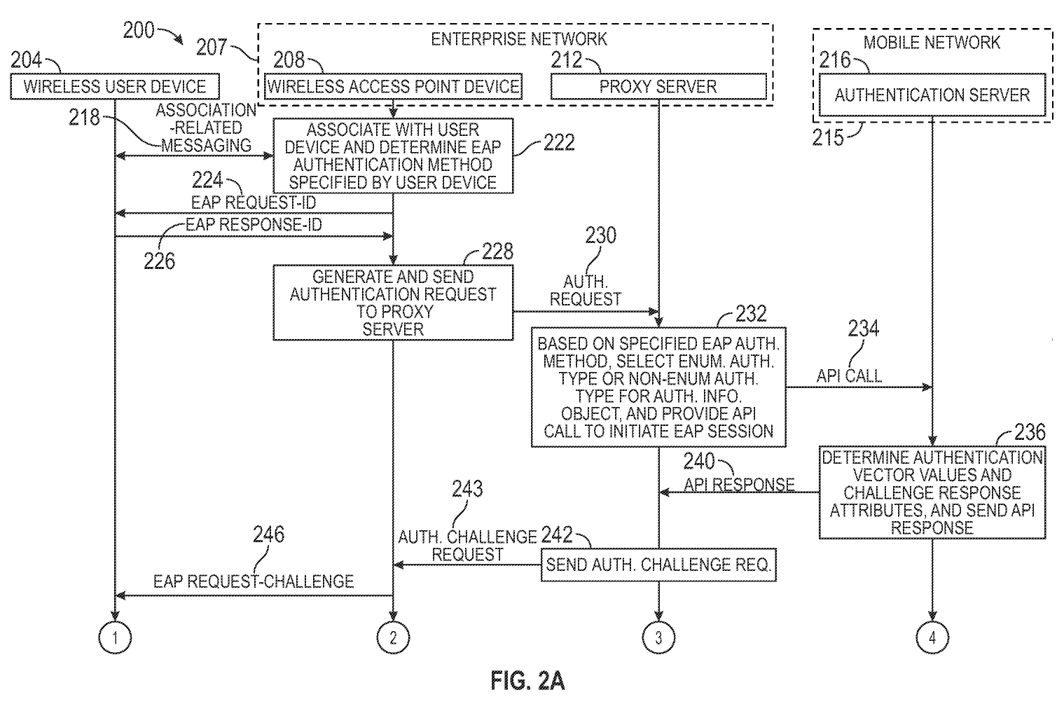

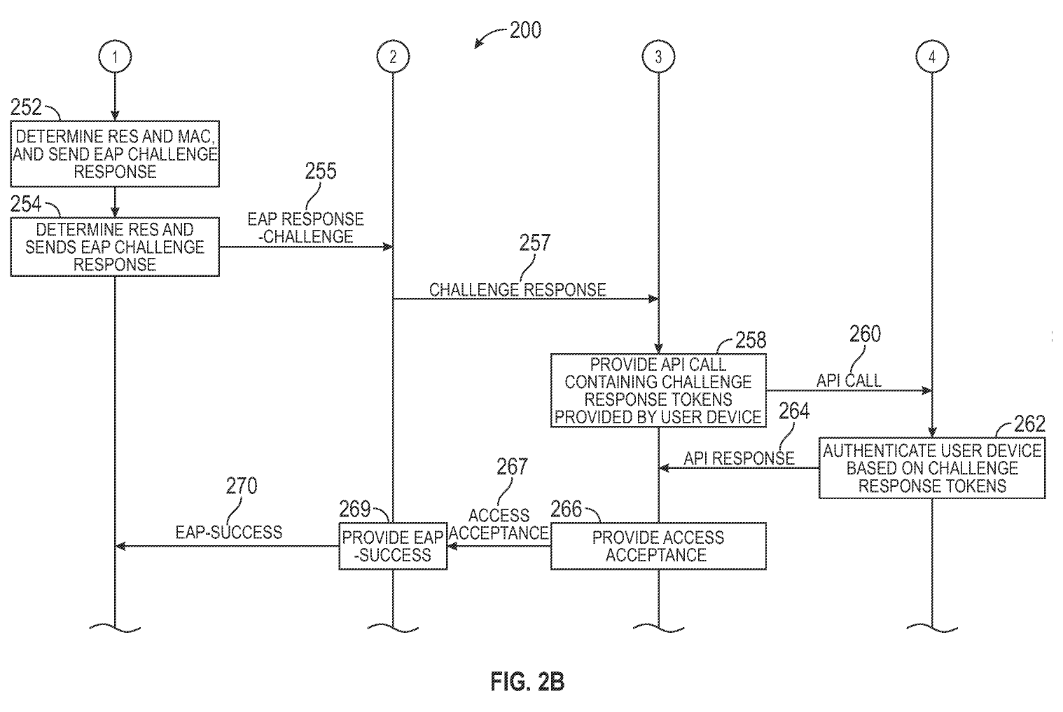

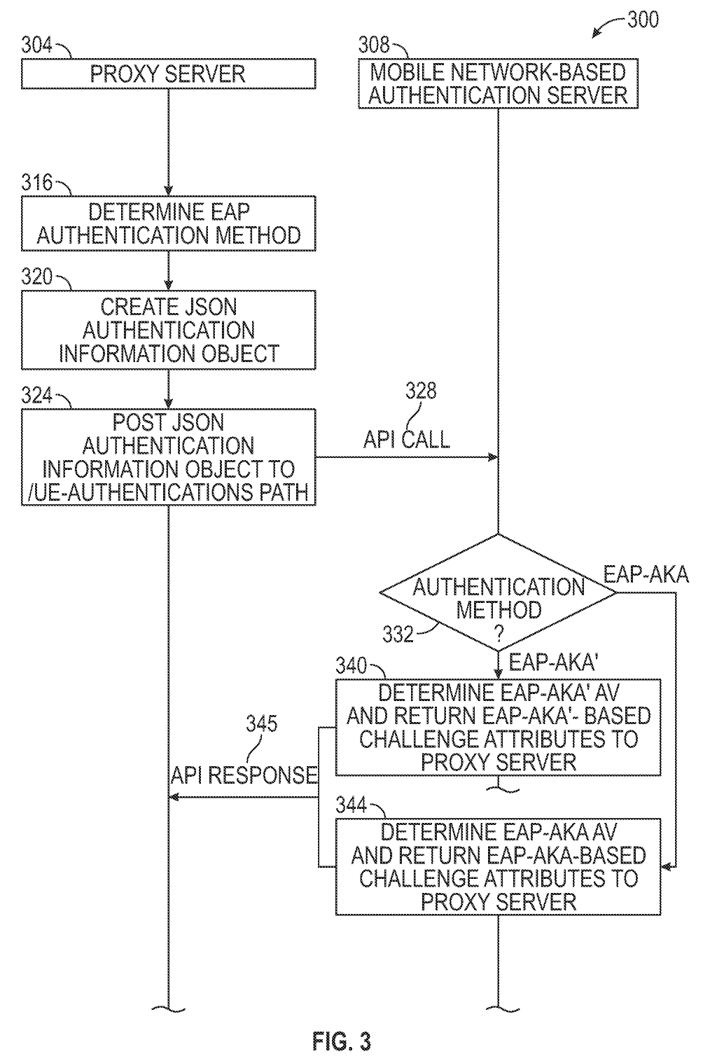

As described in more detail below in connection with FIGS. 2A, 2B and 3, an EAP framework, such as the EAP framework 99, uses a sequence of operations to mutually authenticate a user device and an enterprise network. Still referring to FIG. 1, in a broad overview, the wireless access point device 158 initiates authentication-related operations for the wireless user device 110, by sending, to the proxy server 164, a request to authenticate the wireless user device 110. Responsive to receiving the authentication request, the proxy server 164 initiates what is referred to herein as an "EAP authentication session" (or "EAP session") with the authentication server 183.

In the context that is used herein, a "session" generally refers to a temporary communication period within a time interval that begins when a user device (e.g., the wireless user device 110) associates with an access point device (e.g., the wireless access point device 158) and ends when the user device is no longer associated with the access point device. A session key generally refers to a cryptographic artifact that is generated specifically for use in a particular session. In an example, a session key may be used to encrypt and/or decrypt communications between a user device and an access point device. In another example, a session key may be a seed or an ancestor key of a cryptographic key hierarchy from which one or multiple other keys are derived. An EAP session with the authentication server 183 refers to a temporary communication period associated with the authentication of a user device (e.g., the wireless user device 110).

The proxy server 164, as part of the initiation of the EAP session, instructs the authentication server 183 to apply a particular EAP authentication method that is selected by the wireless user device 110. More specifically, in accordance with example implementations, the proxy server 164 submits an API call to the API 186 for purposes of invoking the AUSF 184 and initiating an EAP session. The API call provides authentication information to the authentication server 183, including information that identifies the wireless user device 110 and data that identifies the EAP authentication method that is specified by the wireless user device 110. In an example, the proxy server 164 providing the API call corresponds to the proxy server 164 providing an HTTP/2 POST of an authentication information object (e.g., a JSON object) to a "/ue-authentications" path of a URL that corresponds to the AUSF 184. The authentication information object includes a string that represents, or corresponds to, the EAP authentication method type (called "AuthType") that is specified by the wireless user device 110.

In an example, the wireless user device 110 specifies the EAP-AKA' authentication method, and AuthType corresponds to a string of "EAP_AKA_PRIME". The EAP-AKA' authentication method is associated with the 5G Authentication Services Standard. In the context, an authentication method (or “authentication protocol," "EAP authentication method," or "EAP authentication protocol") being “associated with” a standard, such as the 5G Authentication Services Standard, refers to the authentication method being recognized by (e.g., mentioned by) the standard. In an example, the EAP-AKA’ authentication method is one of the four enumerated method types (e.g., 5G AKA, EAP-AKA’, EAP-TLS and EAP-TTLS) that are recognized by the 5G Authentication Services Standard, with other non-enumerated authorization method types, such as the EAP-AKA authentication method, not being recognized or mentioned in the 5G Authentication Services Standard. In an example, the 5G Authentication Services Standard sets forth an enumerated set of five strings (e.g., "5G_AKA," "EAP_AKA_PRIME," "EAP_TLS" and "EAP_TTLS") for the AuthType of the authentication information object.

In another example, the wireless user device 110 specifies the EAP-AKA authentication method, and for this example, AuthType corresponds to a string of "EAP_AKA". The 5G Authentication Services Standard is neither associated with the EAP-AKA authentication method nor does the 5G Authentication Services Standard reference or define a string referencing the EAP-AKA authentication method, such as the ”EAP_AKA” string, for AuthType. The authentication information object schema for the 5G Authentication Services Standard, however, defines a generic string type for AuthType. The proxy server 164 takes advantage of the generic string type by setting the AuthType to "EAP_AKA" in the authentication information object to notify the authentication server 183 that the EAP-AKA authentication method is to be used.

The authentication server 183 responds to the API call by generating authentication vector components, or values, according to the specified EAP authentication method. An authentication vector is a collection of authentication-related tokens, or values, which are used for purposes of authenticating the wireless user device 110, authenticating the enterprise network 100 and deriving session keys to protect communications between the wireless user device 110 and the wireless access point device 158. The authentication server 183 therefore authenticates the wireless user device 110 based on an authentication vector, and the wireless user device 110 authenticates the enterprise network 100 based on the same authentication vector. As described herein, the authentication server 183 and the wireless user device 110 both independently apply the specified EAP authentication method to generate authentication vector values. For purposes of generating the authentication vector values on the mobile network side, the AUSF 184, in accordance with example, implementations, calls the back-end ARPF 185, which returns the authentication vector values to the AUSF 184.

The authentication server 183 responds to an EAP session-initiating API call from the proxy server 164 by providing an API response. The API response contains data that represents a generated resource URL. The resource URL is a URL path corresponding to a particular EAP session identifier (ID) and serves as the destination for other API calls, by the proxy server 164, related to the EAP session. The API response also contains data representing attributes that correspond to particular tokens, or values, of the authentication vector, which are components of an authentication challenge request for the wireless user device 110. As further described herein, the authentication challenge request is routed to the wireless user device 110, and the wireless user device's corresponding authentication challenge response is routed back to the proxy server 164.

More specifically, responsive to receiving the wireless user device's authentication challenge response, the proxy server 164 provides, to the authentication server 183, another API call for the same EAP session. The API call communicates tokens of the authentication challenge response to the AUSF function 184. In an example, the API call corresponds to the proxy server 164 providing an HTTP/2 POST to the resource URL that was identified in the previous API response provided by the authentication server 183. The HTTP/2 POST provides data representing the tokens of the wireless user device's authentication challenge response. The authentication server 183, in response to the HTTP/2 POST, applies the specified EAP authentication method to verify the authentication challenge response. The authentication server 183 provides an API response that indicates the authentication result (e.g., the API response indicates an authentication pass or an authentication failure). In response to the wireless user device 110 passing authentication, the API response includes a cryptographic key (e.g., an MSK) from which the session keys protecting data communications over the WLAN link 154 may be derived.

The access point device 158, the proxy server 164, and the mobile network resources 174 that host the authentication server 183 are interconnected by network fabric 160. In accordance with example implementations, the network fabric 160 may be associated with one or multiple types of communication networks, such as Compute eXpress Link (CXL) fabric, dedicated management networks, LANs, WANs, wireless networks, or any combination thereof. The network fabric 160 may include private network fabric of the enterprise network 100, private network fabric associated with the mobile network resources 174, and public network fabric.

The wireless user device 110 may have any of a number of different architectures in accordance with many possible implementations. In accordance with some implementations, the wireless user device 110 may be a computer platform, which may or may not be portable. In examples, the wireless user device 110 may be a mobile telephone device, an Internet of Things (IoT) device; a sensor; a wearable computer; a process controller; an access point device; a Wi-Fi pod device; a Wi-Fi extender device; a desktop computer, a portable computer, a laptop computer, a notebook computer, a tablet computer, a smartphone, a wearable computer, or any other electronic device that has an identity module and a communication interface that is capable of communicating with an access point device.

The enterprise network 100 may have any of a number of different architectures and purposes. In an example, the enterprise network 100 is an edge computing system. In another example, the enterprise network 100 is a private cloud-based computing system. In this context, a "cloud-based computing system" refers to a collection of resources that may be scaled up or down on demand. In another example, the enterprise network 100 is a hybrid cloud-based computing system that includes a private cloud-based computing system and one or multiple public cloud-based computing systems. In another example, the enterprise network 100 is a non-cloud-based computing system. In addition to the wireless access point device(s) 158, the proxy server 164 and network fabric components, the enterprise network 100 have a variety of network components 161, such as servers, client devices, storage devices, and so forth.

In accordance with example implementations, the proxy server 164 includes one or multiple hardware processors. A particular hardware processor corresponds to one or multiple physical processing cores 166 (e.g., central processing unit (CPU) cores). In an example, the proxy server 164 corresponds to one or multiple virtual machines. In another example, the proxy server 164 corresponds to a container hosted on a virtual machine. In another example, the proxy server 164 corresponds to a container pod. In another example, the proxy server 164 corresponds to an orchestrated container cluster. In another example, the proxy server 164 corresponds to a bare-metal environment. In another example, the proxy server 164 corresponds to one or multiple physical servers (e.g., one or multiple blade servers, rack servers or tower servers).

In addition to having one or multiple physical processing cores 166, the proxy server 164 includes a memory 168. The memory 168 stores hardware processor-readable instructions 169 that, when executed by a hardware processor, cause the proxy server 164 to perform operations, as described herein. The proxy server 164 receiving and processing a request or request sent by the wireless access point device 158 is an example of such operations. The proxy server 164 generating and sending a request or response to the wireless access point device 158 is an example of such operations. The proxy server 164 determining the EAP authentication method that is selected by the wireless user device 110 is another example of an operation performed by the proxy server 164. The proxy server 164 communicating with the authentication server 183, including performing operations (e.g., providing API calls and receiving API responses) associated with an EAP session are other examples of such operations. The proxy server 164 generating an authentication information object and embedding an AuthType string representing the authentication method specified by the wireless user device is another example of such an operation. The proxy server 164 including a generic string in an authentication information object to represent a specified EAP authentication method and sending the authentication information object to the authentication server 183 is another example of such operations. The proxy server 164 including an enumerated string in an authentication information object to represent a specified EAP authentication method and sending the authentication information object to the authentication server 183 is another example of such operations.

In general, the memory 168, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

The mobile network resources 174, in accordance with example implementations, are affiliated with a mobile network core and are under control of an MNO. The mobile network resources 174 includes one or multiple hardware processors. A given hardware processor may include one or multiple physical processing cores 178 (e.g., CPU cores) that may be located on one or multiple processing nodes 176. The authentication server 183 may correspond to one or multiple processing nodes 176. In an example, a processing node 176 corresponds to one or multiple virtual machines. In another example, a processing node 176 corresponds to a container that is hosted on a virtual machine. In another example, a processing node 176 corresponds to a container pod. In another example, a processing node 176 corresponds to an orchestrated container cluster. In another example, a processing node 176 corresponds to a bare-metal environment. In another example, a processing node 176 corresponds to a physical server (e.g., a blade server, a rack server or a tower server).

In addition to having one or multiple physical processing cores 178, a processing node 176 includes a memory 180. The memory 180 stores hardware processor-readable instructions 182 that, when executed by a hardware processor, cause the authentication server 183 to provide an API, such as the API 186.

In a more specific example, the instructions 182, when executed by a hardware processor, cause the hardware processor to provide one or multiple API handlers to provide AUSF-related services. In another example, the instructions 182, when executed by a hardware processor, cause the hardware processor to provide ARPF-related services. In another example, the instructions 182, when executed by a hardware processor, cause the hardware processor to service an API call to apply an EAP authentication method selected by a user device (e.g., the wireless user device 110) for purposes of generating authentication vector values and providing a corresponding API response. In an example, providing the API response including providing data representing a challenge request for the wireless user device 110 and providing data that represents a URL resource path for an EAP session.

In another example, the instructions 182, when executed by a hardware processor, provide an API handler to cause the hardware processor to service an API call directed to a URL resource path corresponding to an EAP session. The API handler verifies a challenge response provided by a user device, such as the wireless user device 110, and provides an API response (e.g., an API response that includes data representing a result of the authentication and/or data representing a higher level cryptographic key from which session keys are derived). In another example, the instructions 182, when executed by a hardware processor, provide an API handler to cause the hardware processor to service an API call to generate one or multiple cryptographic keys.

FIGS. 2A and 2B depict an authentication and key agreement sequence flow 200 depicting actions taken by and messaging by components of an EAP framework, in accordance with example implementations. Referring to FIG. 2A, the EAP framework includes components of an enterprise network 207: an EAP authentication method convergence-capable proxy server 212 (called the "proxy server 212" herein) and a wireless access point device 208. Moreover, the EAP framework includes an authentication server 216 (e.g., a 5G authentication server) that is hosted by resources of a mobile network 215.

Pursuant to the sequence flow 200, the wireless access point device 208 and the wireless user device 204 exchange frames corresponding to requests and responses. In an example, the wireless user device 204 has a WLAN radio and a mobile network radio. The wireless user device 204 also contains an identity module (e.g., a SIM or an eSIM). The identity module stores data that either directly represents an authentication secret or represents information from which an authentication secret may be derived. The wireless user device 204 also stores data representing a secret-based EAP authentication method specified for the device 204. In the following discussion, it is assumed that the wireless user device 204 specifies an EAP-AKA authentication method or an EAP-AKA' authentication method. In an example, the wireless access point device 208 is a WiFi device that complies with the IEEE 802.11 family of standards and establishes a WLAN network.

For purposes of onboarding the wireless user device 204 onto the enterprise network 207, the wireless user device 204 and the wireless access point device 208 exchange EAP frames. The EAP frames correspond to EAP messages and EAP responses. Among other purposes, the EAP messages and EAP responses provide an exchange of information that allows the enterprise network 207 to authenticate the wireless user device 204 and allows the wireless user device 204 to authenticate the enterprise network 207. Moreover, through the exchange of EAP frames, the wireless user device 204 and the wireless access point device 208 agree on session keys to be used for purposes of securing communications between the wireless user device 204 and the wireless access point 208 (assuming that the mutual authentication is successful). In an example, the wireless user device 110, the wireless access point device 158, the proxy server 164 and the authentication server 183 of FIG. 1 correspond to the wireless user device 204, the wireless access point device 208, the proxy server 212 and the authentication server 216, respectively.

At the onset of the onboarding process, the wireless user device 204 is initially in a state in which the wireless user device 204 is neither authenticated nor associated with the wireless access point device 208. The wireless user device 204 begins the onboarding process by wirelessly connecting to the wireless access point device 208 to initiate an association subprocess. In accordance with example implementations, the wireless access point device 208 initially restricts the communication between the wireless user device 204 and the wireless access point device 208 to EAP management-related frames (e.g., the wireless access point device 208 drops any data frames sent by the wireless user device 204). The wireless access point device 208 removes the restriction responsive to the wireless user device 204 transitioning to a state in which the wireless user device 204 is associated with the wireless access point device 208 and the wireless user device 204 has passed what is referred to herein as a "high-level authentication."

As a more specific example, the onboarding process includes the wireless user device 204 first communicating with the wireless access point device 208 to achieve a "low-level authentication." As an example, the low-level authentication may be an open system authentication that is described in the IEEE 802.11 standard. As a more specific example, the wireless user device 204 may send an IEEE 802.11 authentication frame to the wireless access point device 208. The wireless access point device 208 may then respond to the authentication frame with an authentication response frame, which places the wireless user device 204 in a state in which the wireless user device 204 has been low-level authenticated and has not yet been associated with the wireless access point device 208.

Next, as part of the onboarding process, as depicted at 222, the access point device 208 associates with the wireless user device 204, and as part of the association, the access point device 208 determines an EAP authentication method that is specified by the wireless user device 204. More specifically, the wireless access point device 208 and the wireless user device 204 perform association-related messaging 218. In an example, the association-related messaging 218 includes the wireless user device 204 first sending an association request frame to the wireless access point device 208. The association request frame may contain data that represents capabilities (e.g., encryption types, supported rates, supported channels, quality of service (QoS) capability, and other properties) of the wireless user device 204. In an example implementations, the association request frame contains data that represents an EAP authentication method (e.g., EAP-AKA or EAP-AKA') that is specified by the wireless user device 204.

Assuming capabilities of the wireless user device 204 match capabilities of the wireless access point device 208, the wireless access point device 208, as part of the association-related messaging 218, sends an association frame that contains an association identifier (ID) for the wireless user device 204. At this point, the association messaging 218 is complete, the wireless user device 204 has a state in which the wireless user device 204 is low-level authenticated, and the wireless user device 204 is associated with the wireless access point device 208.

Next, the sequence 200 includes an exchange of frames that corresponds to high-level mutual authentication and provides information from which the enterprise network 207 may authenticate the wireless user device 204 and the wireless user device 204 may authenticate the enterprise network 207. This exchange of frames begins with the wireless access point device 208 sending, to the wireless user device 204, an EAP identity request 224 requesting identifying information from the wireless user device 204. The wireless user device 204 responds to the EAP identity request 224 by sending, to the wireless access point device 208, an EAP identity response 226. In an example, the EAP identity response 226 includes data representing an NAI and an IMSI associated with the wireless user device 204. In an example, the processing of the EAP identity request 224, including the generation of the EAP identity response 226, is handled by the wireless user device's identity module.

The wireless access point device 208, responsive to receiving the EAP identity response 226, generates and sends (as depicted at 228), an authentication request 230 (e.g., a RADIUS Access-Request message) to the proxy server 212. The authentication request 230 contains data that represents information that the authentication server 216 processes to generate authentication vector components and generate tokens for an authentication challenge request for the wireless user device 204. In an example, the authentication request 230 contains data representing identifying information for the wireless user device 204, such as a data representing an NAI and IMSI for the wireless user device 204. In an example, the authentication request 230 contains data representing the EAP authentication method that is specified by the wireless user device 204.

The authentication request 230 may also include data representing information specific to the specified EAP authentication method. For example, if the wireless user device 204 specifies the EAP-AKA' authentication method, then the wireless access point device 208 includes data in the authentication request 230 representing the access network name (e.g., the name of the corresponding WLAN), as the EAP-AKA' authentication method binds cryptographic keys to the access network name. Stated differently, the EAK-AKA' authentication method binds an authentication vector to the access network name in that certain values of the authentication vector are bound to the access network name. In another example, the wireless access point device 208 includes data in the authentication request 230 representing the access network name regardless of the particular specified EAP authentication method, and the authentication server 216 may or may not use this information.

The sending of the authentication request 230 to the proxy server 212 prompts the proxy server 212 to, as depicted at 232, provide an API call 234 to the authentication server 216 to initiate an EAP session. In an example, in preparation for providing the API call 234, the proxy server 212 determines the EAP authentication method specified by the wireless user device 204 and generates an authentication information object (e.g., a JSON object). The proxy server 212 includes a string (corresponding to an AuthType property of the authentication information object) in the authentication information object, which identifies the EAP authentication method. In an example, providing the API call 234 includes the proxy server 212 providing an HTTP/2 POST to a URL path (e.g., "/ue-authentications") corresponding to an AUSF of the authentication server 216.

The proxy server 212 embeds other information in the authentication object associated with the API call 234, depending on the particular specified EAP authentication method. In an example, for the EAP-AKA authentication method, the proxy server 212 includes, as an example, the user device's NAI and IMSI. In another example, for the EAP-AKA' authentication, the proxy server 212 includes, as an example, an access network name (e.g., the WLAN name associated with the access point device 208) in addition to the user device's NAI and IMSI.

In response to the API call 234, the authentication server 216, as depicted at 236, determines authentication vector values, determines attributes for a challenge request for the wireless user device 204, and provides a corresponding API response 240 (that is sent back to the proxy server 212). More specifically, in accordance with example implementations, the authentication server's AUSF, in response to the API call 234, relies on a back-end ARPF to generate authentication vector values using the specified EAP authentication method. An attribute corresponding to an authentication vector value, in the context that is used herein, refers to the attribute containing data that represents the authentication vector value. An attribute may also contain data representing additional information (e.g., data corresponding to an attribute identifier, data representing a length of the attribute, and so forth) other than an authentication vector value.

The authentication vector for the EAP-AKA authentication method may be described as follows: <RAND, AUTN, RES, CK, IK>. The authentication server 216 applies the EAP-AKA authentication method to generate the RAND, AUTN, CK and IK values of the authentication vector. The authentication vector for the EAP-AKA' authentication method may be described as follows: <RAND, AUTN, RES, CK', IK'>. The authentication server 216 applies the EAP-AKA' authentication method to generate the RAND, AUTN, CK' and IK' values of the authentication vector.

The RAND and AUTN values correspond to AT_RAND and AT_AUTN attributes, respectively. The AT_AUTN attribute is verified by the wireless user device 204 for purposes of the wireless user device 204 authenticating the network 207. The AT_RAND and AT_AUTN attributes are included in an authentication challenge request for the wireless user device 204. The authentication server 216 randomly or pseudorandomly generates the RAND value, which serves as an authentication challenge value for the wireless user device 204. The wireless user device 204 applies a keyed cryptographic hash algorithm that receives the AT_RAND attribute as an input and receives a key input corresponding to the user device's secret to produce a challenge response value called "RES." The authentication server 216 expects the RES value to be equal to an expected RES value, called the "XRES value."

The API response 240 includes data representing an authentication challenge request for the wireless user device 204. In addition to the AT_RAND and AT_AUTN attributes, the authentication challenge request includes a message authentication code (MAC) attribute, called "AT_MAC," which the wireless user device 204 processes to authenticate the authentication challenge request. In addition to the authentication challenge request, the API response 240 includes data representing a URL resource path, which includes an EAP session ID and is used by the proxy server 212 to POST an authentication challenge response from the wireless user device 204, as further described herein.

The CK and IK values correspond to a cipher key and an integrity key, respectively, which are produced by the EAP-AKA authentication method. The CK and IK values correspond to high level session keys of a session key hierarchy. Lower-level session keys of the session key hierarchy are derived from the CK and IK values and are used to secure data communications between user device 204 and the wireless access point device 208 (assuming mutual authentication is successful).

The authentication server 216, pursuant to the EAP-AKA authentication method, derives cryptographic keys from the CK and IK values. For example, the authentication server 216 derives, based on the CK and IK values, a key that serves as the key input for the cryptographic hash algorithm that produces the MAC value and corresponding AT_MAC attribute. Moreover, using the EAP-AKA authentication method, the authentication server 216 derives, from the CK and IK values, another session key (e.g., an MSK) from which at lower level pairwise transient (PTK) key may be derived for unicast traffic encryption/decryption, and a Group Transport Key (GTK) may be derived for multicast traffic encryption/decryption.

Similar to the CK and IK values, the CK' and IK' values correspond to high level session keys of a session key hierarchy; and lower-level session keys of the session key hierarchy are derived from the CK' and IK' values for a number of purposes. For example, the authentication server 216 derives, based on the CK' and IK' values, a key that serves as the key input for the cryptographic hash algorithm that produces the MAC value (from which the AT_MAC token is derived). In another example, the authentication server 216 derives, based on the CK' and IK' values, session keys to secure data communications between user device 204 and the wireless access point device 208 (assuming mutual authentication is successful).

Unlike the CK and IK values, the CK' and IK' values are bound to a network access name (e.g., the name of the WLAN associated with the wireless access point device 208). More specifically, pursuant to the EAP-AKA' authentication method, the authentication server 216 derives the CK' and IK' values by first determining the CK and IK values (similar to the derivation by the EAP-AKA authentication method) and then deriving the CK' and IK' values from the CK and IK attributes. In particular, the CK' and IK' values are derived from the CK and IK attributes as described in Release 14 of TS 133402 entitled, "Security Aspects of Non-3GPP Accesses," Version 14.3.0 (October 2017), published in the United States by ATIS.

Responsive to receiving the API response 240, the proxy server 212 sends an authentication challenge request 243 (e.g., a RADIUS Access-Challenge message) to the wireless access point device 208. The authentication challenge request 243 contains the AT_RES , AT_AUTN and AT_MAC attributes. The wireless access point device 208, in response to receiving the authentication challenge request 243, sends an EAP challenge request 246 containing the AT_RAND, AT_MAC and AT_AUTN attributes to the wireless user device 204.

Referring to FIG. 2B in conjunction with FIG. 2A, the wireless user device 204, as depicted at 252, authenticates the enterprise network 207 based on the EAP challenge request 246. For this purpose, the wireless user device 204 applies its specified EAP authentication method to independently generate components of the authentication vector, including an expected AUTN value. Moreover, the wireless user device 204 applies the specified EAP authentication method to independently generate the CK and IK values (for the EAP-AKA authentication method) or the CK' and IK' values (for the EAP-AKA' authentication method). The wireless user device 204 also applies the specified EAP authentication method to determine an expected AT_MAC attribute for the EAP challenge request 246. The wireless user device 204 uses the expected AT_MAC attribute and the expected AT_AUTN attribute to verify the identity of the network 207. If the wireless user device 204 determines that both the AUTN attribute and the AT_MAC attribute contained in the EAP challenge request 246 (FIG. 2A) are expected, then the enterprise network 207 passes the wireless user device's authentication. If the authentication by the wireless user device 204 fails, then the wireless user device 204 disassociates from the access point device 208.

Otherwise, if the wireless user device 204 successfully authenticates the enterprise network 207, then the wireless user device 204 proceeds to, as depicted at 254, generate and send an EAP challenge response 255. The EAP challenge response message 255 contains an AT_RES attribute (corresponding to the RES value) and an AT_MAC attribute (corresponding to a MAC value) for the EAP challenge response 255. The wireless access point device 208, responsive to the EAP challenge response 255, sends, to the proxy server 212, a challenge response 257 (a RADIUS Access-Request message) containing the AT_RES and AT_MAC attributes. As depicted at 258, the proxy server 212, responsive to the access request message 257, provides an API call 260 to the authentication server 216. In an example, the proxy server 212 makes an HTTP/2 POST to the URL resource path identified in the API response 240 (FIG. 2A). The POSTed data includes data containing the AT_RES and AT_MAC attributes provided by the wireless user device 204. As depicted at 262, the authentication server 216 authenticates the wireless user device 204 (i.e., verifies the AT_RES and AT_MAC attributes), and responsive to successful authentication, the authentication server 216 provides, for this example, an API response 264 indicating the successful authentication.

In accordance with example implementations, in addition to indicating successful authentication, the API response 264 contains data representing a session key (e.g., an MSK). As depicted at 266, the proxy server 212, responsive to the API response 264, sends an access acceptance notification 267 (e.g., a RADIUS Access-Accept message) to the wireless access point device 208. In accordance with example implementations, the access acceptance notification 267, in addition to indicating authorization for the wireless user device 204 to join the enterprise network 207, also includes data representing a session key (e.g., an MSK from which lower-level session keys may be derived to encrypt and decrypt communications). The wireless access point device 208, responsive to the success notification 267, sends an EAP success message 270 to the wireless user device 204 indicating acceptance to join the enterprise network 207. Due to the application of the specified EAP authentication method by the wireless user device 204, the wireless user device 204 has possession of the same session key (e.g., the MSK) that has been provided to the wireless access point device 208. Using the EAPoL four-way handshake, the wireless user device 204 and the wireless access point device 208 may then exchange management frames that allow each device 204 and 208 to derive a PTK for unicast traffic encryption/decryption, and possibly derive a GTK for multicast traffic encryption/decryption.

FIG. 3 depicts a sequence flow 300 depicting a mobile network-based authentication server's selection and application of a user device-specified EAP authentication method to derive an authentication vector and challenge attributes according to example implementations. Referring to FIG. 3, a proxy server 304 of an enterprise network performs the actions depicted in FIG. 3 in response to receiving an authorization request (e.g., a RADIUS Access-Request message) from a wireless access point device. The proxy server 304 communicates with a mobile network-based authentication server 308 for purposes of deriving attributes for an access-challenge that the proxy server 304 sends back to a wireless access point device. The proxy server 164 of FIG. 1 and the proxy server 212 of FIG. 2 are examples of the proxy server 304 of FIG. 3. The authentication server 183 of FIG. 1 and the authentication server 216 of FIG. 2 are examples of the authentication server 308 of FIG. 3.

The proxy server 304, responsive to the authentication request, first determines, as depicted at 316, the EAP authentication method that is specified by the wireless user device. In an example, the determination includes the proxy server 304 determining whether the wireless user device has specified an EAP-AKA authentication method or an EAP-AKA' authentication method. Next, as depicted at 320, the proxy server 304 creates a JSON authentication information object for purposes of passing, to the authentication server 308, relevant information about the authentication.

In an example, the JSON authentication information object includes data that identifies an authentication type that corresponds to the EAP authentication method specified by the wireless user device. In accordance with example implementations, the proxy server 304 constructs the JSON authentication information object to contain an AuthType string of either "EAP_AKA_PRIME" (for the case of the wireless user device specifying the EAP-AKA' authentication method) or "EAP_AKA" (for the case of the wireless user device specifying the EAP-AKA authentication method). In an example, the authentication server 308 is a 5G server, and the 5G authentication services standard defines enumerated strings for corresponding EAP authentication methods recognized by the standard. The "EAP_AKA_PRIME" string is a specifically enumerated string that is set forth in the 5G authentication services standard and corresponds to the EAP-AKA' authentication method, which is defined by the standard. The "EAP_AKA" string is not one of the enumerated strings set forth in the 5G authentication services standard, as such an identifier corresponds to the EAP-AKA authentication that, in the standard, is replaced by the EAP-AKA' authentication method. The object schema defined in the 5G authentication services standard does, however, allow a generic string type for the AuthType property of the authentication information object. The authentication proxy server 304 takes advantage of this feature to include a string of "EAP_AKA" for AuthType to indicate, to the authentication server 308, that the EAP-AKA authentication method is to be used.

As depicted at 324, the proxy server 304 POSTs a JSON authentication information object to the authentication server 308 for purposes of providing an API call 328. In an example, the API call 328 corresponds to the proxy server 304 providing an HTTP/2 POST of the JSON authentication information object to a "/ue-authentications" path of a URL corresponding to an AUSF served by the authentication server 308. Responsive to the API call 328, the authentication server 308 determines (as depicted at 332) the particular selected EAP authentication method from the AuthType string contained in the JSON authentication information object.

For the EAP-AKA' authentication method, the authentication server 308 determines (as depicted at 340) the corresponding authentication vector, and the authentication server 308 returns to the proxy server 304, via an API response 345, the corresponding challenge attributes for the wireless user device. For the EAP-AKA authentication method, the authentication server 308 determines (as depicted at 344) the corresponding authentication vector and returns, to the proxy server 304, via the API response 345, the corresponding challenge attributes for the wireless user device.

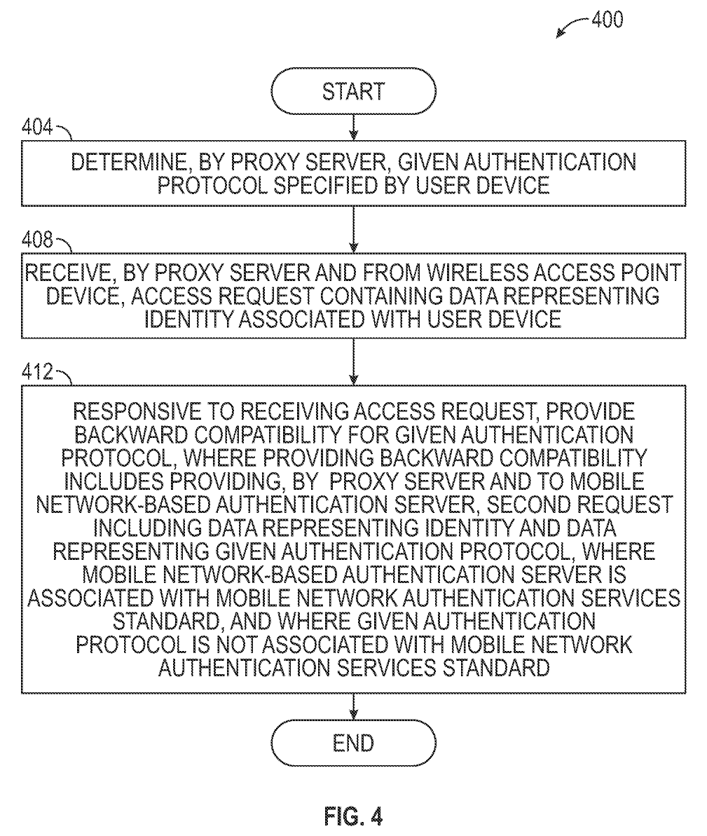

Referring to FIG. 4, in accordance with example implementations, a technique 400 includes determining (block 404), by a proxy server, a given authentication protocol that is specified by a user device. In an example, the proxy server is a RADIUS server whose authentication and authorization functions are offloaded to a mobile network-based authentication server. In an example, the proxy server is constructed to converge 4G and 5G authentication methods.

In an example, the given authentication protocol is an EAP-AKA authentication method. In another example, the given authentication protocol is an EAP-AKA' authentication method. In an example, the given authentication protocol is specified as part of the user device's WPA-2 Enterprise profile. In an example, the authentication protocol is specified by a manufacturer of the user device. In an example, the given authentication protocol is specified by an MNO. In an example, the given authentication protocol is selected by a user of the user device.

In examples, the wireless user device may be a mobile telephone device, an Internet of Things (IoT) device; a sensor; a wearable computer; a process controller; an access point device; a Wi-Fi pod device; a Wi-Fi extender device; a desktop computer, a portable computer, a laptop computer, a notebook computer, a tablet computer, a smartphone, a wearable computer, or any other electronic device that has an identity module and a communication interface that is capable of communicating with an access point device.

The technique 400 includes receiving (block 408), by the proxy server and from a wireless access point device, an access request that corresponds to the user device. The access request includes data representing an identity associated with the user device. In an example, the wireless access point device creates a WLAN. In an example, receiving the access request occurs after the user device associates with the wireless access point device. In an example, the identity includes an IMSI. In an example, the access request corresponds to a RADIUS Access-Request message.

The technique 400 includes, pursuant to block 412, responsive to receiving the access request, providing backward compatibility for the given authentication protocol. Providing backward compatibility includes providing, by the proxy server and to a mobile network-based authentication server a second request. The second request includes data representing the identity and data representing the given authentication protocol. In an example, the authentication server is a 5G authentication server. In an example, providing the second request includes calling an API that is served by the authentication server. In an example, providing the second request includes invoking an AUSF. In an example, providing the second request includes the proxy server providing an HTTP/2 POST to a URL associated with the authentication server. Providing the second request, in an example, includes POSTing an authentication information object to a URL associated with the authentication server. In an example, the authentication information object is a JSON object. In an example, the JSON object includes an authorization type property setting forth an authentication protocol. In an example, providing the second request includes the proxy server setting the authorization type to a generic string representing the given authentication protocol.

In an example, providing the second request causes the authentication server to provide an API response. In an example, the API response includes attributes corresponding to an authentication challenge for the user device. In an example, the attributes for the authentication challenge include a randomly or pseudorandomly generated value. In an example, the attributes for the authentication challenge for the user device corresponds to a MAC.

As depicted in block 412, the authentication server is associated with a mobile network authentication services standard, and the given authentication protocol is not associated with the mobile network authentication services standard. In an example, the mobile network authentication services standard is a 5G authentication services standard. In an example, the 5G authentication services standard supports the EAP-AKA' authentication method, and the given authentication protocol is the EAP-AKA authentication protocol, which is not supported by the 5G authentication services standard. In an example, the 5G authentication services standard defines a set of enumerated strings corresponding to respective authentication methods that are supported by the 5G authentication services standard. In an example, the 5G authentication services standard has object schema defining an enumerated string type having enumerated strings corresponding to the authentication methods that are supported by the 5G authentication services standard, and the object schema further allows for a generic string type. In an example, the proxy server providing the second request corresponds to the proxy server providing an authentication information object that has a string corresponding to the generic string type and representing the given authentication protocol.

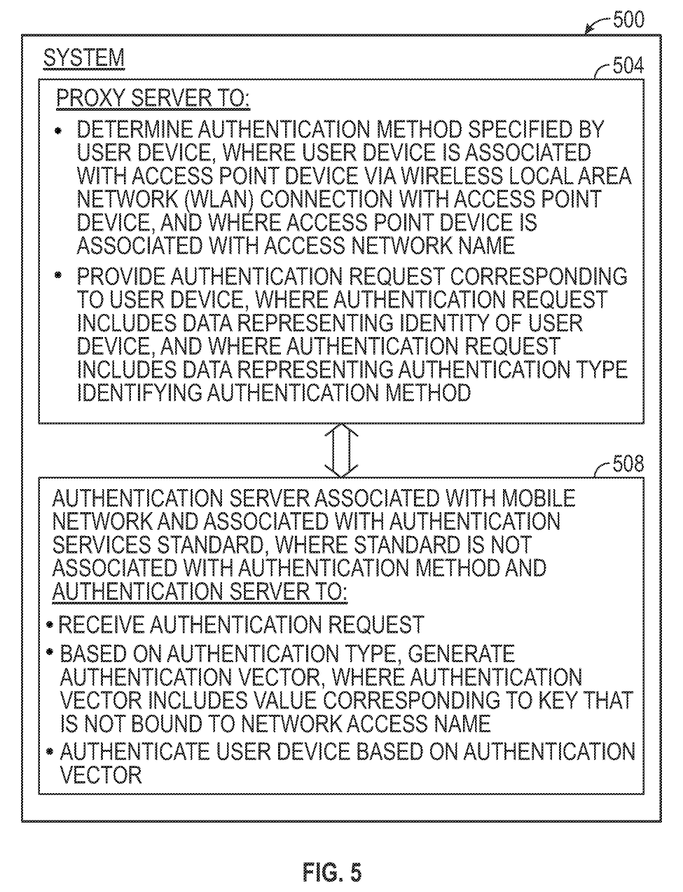

Referring to FIG. 5, in accordance with example implementations, a system 500 includes a proxy server 504 and an authentication server 508 that is associated with a mobile network and is associated with an authentication services standard. In an example, the proxy server 504 is an EAP authentication method convergence-capable proxy server that accommodates current and prior generation mobile network-based EAP authentication methods. In an example, the authentication server 508 is a 5G authentication server. In an example, the authentication services standard is a 5G authentication services standard.

The proxy server 504 to determine an authentication method that is specified by a user device. In an example, the authentication method is the EAP-AKA authentication method. In another example, the authentication method is an EAP-AKA' authentication method. In an example, the wireless user device may be a mobile telephone device, an IoT device; a sensor; a wearable computer; a process controller; an access point device; a Wi-Fi pod device; a Wi-Fi extender device; a desktop computer, a portable computer, a laptop computer, a notebook computer, a tablet computer, a smartphone, a wearable computer, or any other electronic device that has an identity module and a communication interface that is capable of communicating with an access point device.

The user device is associated with an access point device via a WLAN connection with the access point device. The access point device is associated with an access network name. The proxy server 504 provides an authentication request corresponding to the user device. In an example, the authentication request corresponds to the proxy server invoking an AUSF function served by the authentication server 508. In an example, the proxy server provides the authentication request by POSTing an authentication information object to a URL path associated with the authentication server 508.

The authentication request includes data representing an identity of the user device, and the authentication request includes data representing an authentication type identifying the authentication method. In an example, the identity corresponds to an IMSI. In an example, the data representing the authentication type corresponds to a string. In an example, the data representing the authentication type corresponds to a generic string type defined by object schema of the authentication services standard.

The authentication method is not associated with the authentication services standard. The authentication server 508 receives the authentication request and based on the authentication type, generates an authentication vector. In an example, the authentication server 508 generates the authentication vector by applying an EAP-AKA authentication method. In an example, the authentication vector includes a randomly or pseudorandomly value used as a challenge for the user device. In an example, the authentication vector includes a value used, by the user device, to authenticate the network. In an example, the authentication value includes a cryptographic key that is not bound to a network access name. The authentication server 508 authenticates the user device based on the authentication vector.

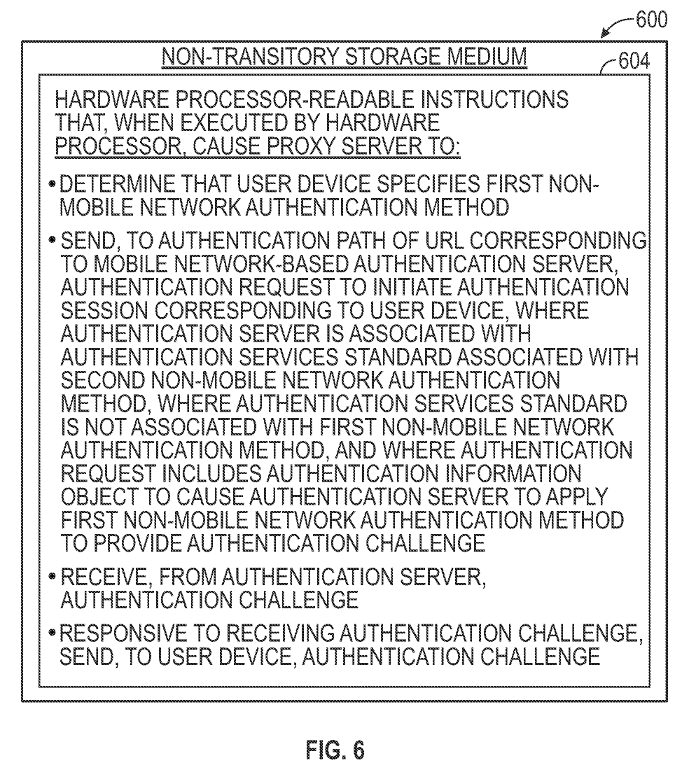

Referring to FIG. 6, in accordance with example implementations, a non-transitory storage medium 600 stores hardware processor-readable instructions 604. In an example, the hardware processor includes one or multiple CPU cores. In an example, the non-transitory storage medium includes one or multiple semiconductor storage devices.

The instructions 604, when executed by the hardware processor, cause a proxy server to determine that a user device specifies a first non-mobile network authentication method. In an example, the non-mobile network authentication method corresponds to a regulation of non-3GPP access. In an example, the first non-mobile network authentication method is an EAP-AKA authentication method.

The instructions 604, when executed by the hardware processor, further cause the hardware processor to send, to an authentication path of a URL corresponding to a mobile network-based authentication server, an authentication request to initiate an authentication session corresponding to the user device. In an example, the authentication session corresponds to an EAP session, and the authentication server assigns a session ID to the authentication session. In an example, the authentication server responds to the authentication request with a response containing data that identifies a resource associated with a session ID. In an example, the resource path is a URL path.

The authentication server is associated with an authentication services standard associated with a second non-mobile network authentication method. In an example, the second non-mobile network authentication method is an EAP-AKA' authentication method. The authentication services standard is not associated with the first non-mobile network authentication method, and the authentication request includes an authentication information object to cause the authentication server to apply the first non-mobile network authentication method to provide an authentication challenge. In an example, the authentication information object is a JSON object. In an example, the JSON object includes an authorization type corresponding to a string that identifies the first non-mobile network authentication method. In an example, the authentication challenge includes a randomly or pseudorandomly generated number. In an example, the authentication server generates an expected response, by the user device, to the number. In an example, the expected response corresponds to a response produced using the randomly or pseudorandomly generated number and a secret possessed by the user device.

The instructions 604, when executed by the hardware processor, further cause the hardware processor to receive, from the authentication server, the authentication challenge. In an example, the authentication challenge corresponds to an API response produced by an AUSF served by the authentication server.

The instructions 604, when executed by the hardware processor, further cause the hardware processor to, responsive to receiving the authentication challenge, send, to the user device, the authentication challenge. In an example, sending the authentication challenge to the user device includes the proxy server providing a RADIUS Authentication-Challenge message to a wireless access point device, and the wireless access point device sends a corresponding EAP request to the user device.

In accordance with example implementations, the mobile network authentication services standard specifies a set of enumerated strings that correspond to enumerated authentication services associated with the mobile network standard. Providing backward compatibility for the given authentication protocol includes providing, by the proxy server and to the authentication server, data representing a non-enumerated string that is not in the set of enumerated strings and represents the given authentication protocol. Among the potential benefits, authentication methods may be applied by authentication servers that are associated with authentication services standards that do not support a particular authentication method.

In accordance with example implementations, the mobile authentication services standard specifies a schema that defines a generic string type for the enumerated authentication services. The non-enumerated string corresponds to the generic string type. Among the potential benefits, authentication methods may be applied by authentication servers that are associated with authentication services standards that do not support a particular authentication method.

In accordance with example implementations, providing backward compatibility for the authentication protocol further includes receiving, by the proxy server and from the authentication server, a response to the second request. The response includes data that represents a challenge value that is generated by the authentication server. Providing backward compatibility further includes sending, by the proxy server and to the wireless access point device, a challenge request for the user device. The challenge request includes data that represents the challenge value. Among the potential benefits, authentication methods may be applied by authentication servers that are associated with authentication services standards that do not support a particular authentication method.

In accordance with example implementations, the response to the second request includes data representing a URL that corresponds to a resource that is associated with an authentication session. Providing backward compatibility for the authentication protocol further includes providing, by the proxy server and to the URL, data that represents a response by the user device to the challenge value. Among the potential benefits, authentication methods may be applied by authentication servers that are associated with authentication services standards that do not support a particular authentication method.

In accordance with example implementations, an authentication result is received by the proxy server responsive to providing data representing the response by the user device to the challenge value. Among the potential benefits, authentication methods may be applied by authentication servers that are associated with authentication services standards that do not support a particular authentication method.

In accordance with example implementations, the mobile authentication services standard is associated with a second authentication protocol, the second authentication protocol is associated with a first authentication vector, and the second authentication protocol binds the authentication vector to a network access name. The given authentication protocol is associated with a second authentication vector, and the given authentication vector does not bind the second authentication vector to the network access name. Among the potential benefits, authentication methods may be applied by authentication servers that are associated with authentication services standards that do not support a particular authentication method.

In accordance with example implementations, the first authentication vector includes a first session key, and the given authentication vector includes a second session key that is bound to the access network name and is derived from the first session key. Among the potential benefits, authentication methods may be applied by authentication servers that are associated with authentication services standards that do not support a particular authentication method.

In accordance with example implementations, the mobile network authentication services standard specifies a set of enumerated strings that correspond to the enumerated authentication services associated with the mobile network standard. Providing backward compatibility for the given authentication protocol includes providing, by the proxy server and to the authentication server, data representing a non-enumerated string that is not in the set of enumerated strings and represents the given authentication protocol. Among the potential benefits, authentication methods may be applied by authentication servers that are associated with authentication services standards that do not support a particular authentication method.

In the context that is used herein, a "hash" (which may also be referred to by such terminology as a "digest," "hash value," or "hash digest") is produced by the application of a cryptographic hash algorithm to an input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address). In such an example, based on the string of data, the cryptographic hash algorithm outputs a hexadecimal string (the digest, or hash). Any minute change to the input value alters the output hexadecimal string. In examples, the cryptographic hash function may be a secure hash algorithm (SHA), a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

In the context that is used herein, a "keyed-hash algorithm" refers to a function that uses a cryptographic hash algorithm (e.g., an SHA, a FIPS-approved hash algorithm, an NIST-approved hash algorithm or other hash algorithm) to generate a digest, or hash, based on a cryptographic key input and a second input (called a “message input”). The keyed-hash algorithm derives an input for the keyed-hash algorithm from the cryptographic key and the message input. A keyed-hash algorithm may derive a digest, or hash, using a single pass or multiple iterations of the algorithm. In an example, a keyed-hash algorithm may form an input value for the cryptographic hash algorithm based on a concatenation of the cryptographic key and the message input. In another example, an input for a keyed-hash algorithm is formed from the concatenation of a key derived from the cryptographic key and the message input. In another example, a first key (also called "an inner key") and a second key (also called an "outer key") are derived from the cryptographic key. In a first iteration, or pass (also called the "inner pass") of the keyed-hash algorithm, the first key and the message input are combined to provide a first input value to the keyed-hash algorithm, which provides a first digest (also called the "inner digest result"). In a second iteration, or pass (also called the "outer pass"), of the keyed-hash algorithm, the second key and the first digest are combined to provide a second input value to the hash algorithm, which provides a second digest, which is the output, or result.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
determining, by a proxy server, a given authentication protocol specified by a user device;
receiving, by the proxy server and from a wireless access point device, an access request corresponding to the user device, wherein the access request comprises data representing an identity associated with the user device; and
responsive to receiving the access request, providing backward compatibility for the given authentication protocol, wherein providing backward compatibility comprises providing, by the proxy server and to a mobile network-based authentication server, a second request comprising data representing the identity and data representing the given authentication protocol, wherein the mobile network-based authentication server is associated with a mobile network authentication services standard, and wherein the given authentication protocol is not associated with the mobile network authentication services standard.

2. The method of claim 1, wherein:
the mobile network authentication services standard specifies a set of enumerated strings corresponding to enumerated authentication services associated with the mobile network standard; and
providing backward compatibility for the given authentication protocol comprises providing, by the proxy server and to the authentication server, data representing a non-enumerated string not in the set of enumerated strings and representing the given authentication protocol.

3. The method of claim 2, wherein:
the mobile network authentication services standard specifies a schema defining a generic string type for the enumerated authentication services; and
the non-enumerated string corresponds to the generic string type.

4. The method of claim 1, wherein providing backward compatibility for the authentication protocol further comprises:
receiving, by the proxy server and from the authentication server, a response to the second request, wherein the response comprises data representing a challenge value generated by the authentication server; and
sending, by the proxy server and to the wireless access point device, a challenge request for the user device, wherein the challenge request comprises data representing the challenge value.

5. The method of claim 4, wherein:
the response to the second request comprises data representing a Uniform Resources Location (URL) corresponding to a resource associated with an authentication session; and
providing backward compatibility for the authentication protocol further comprises providing, by the proxy server and to the URL, data representing a response by the user device to the challenge value.

6. The method of claim 5, further comprising, responsive to providing data representing the data representing the response by the user device to the challenge value, receiving, by the proxy server and from the authentication server, an authentication result.

7. The method of claim 1, wherein:
the mobile network authentication services standard is associated with a second authentication protocol;
the second authentication protocol is associated with a first authentication vector;
the second authentication protocol binds the authentication vector to a network access name;
the given authentication protocol is associated with a second authentication vector; and
the given authentication vector does not bind the second authentication vector to the network access name.

8. The method of claim 7, wherein:
the first authentication vector comprises a first session key; and
the given authentication vector comprises a second session key bound to the access network name and derived from the first session key.

9. The method of claim 1, wherein:
the given authentication protocol comprises a first shared secret-based authentication protocol that generates first authentication vector values and does not bind the first authentication vector values to a network access name associated with the wireless access point device; and
the mobile network authentication services standard is associated with a second shared secret-based authentication protocol that generates second authentication vector values and binds the second authentication vector values to the network access name.

10. A system comprising:
a proxy server to:
determine an authentication method specified by a user device, wherein the user device is associated with an access point device via a wireless local area network (WLAN) connection with the access point device, and wherein the access point device is associated with an access network name; and
provide an authentication request corresponding to the user device, wherein the authentication request comprises data representing an identity of the user device, and wherein the authentication request comprises data representing an authentication type identifying the authentication method; and
an authentication server associated with a mobile network and associated with an authentication services standard, wherein the authentication services standard is not associated with the authentication method, and the authentication server to:
receive the authentication request;
based on the authentication type, generate an authentication vector, wherein the authentication vector comprises a value corresponding to a key that is not bound to an access network name; and
authenticate the user device based on the authentication vector.

11. The system of claim 10, wherein the proxy server to further:
select a string corresponding to a generic string type defined by the authentication services standard; and
include the string in an authentication information object of the authentication request to represent the authentication type.

12. The system of claim 10, wherein:
the authentication server to further, responsive to the request, generate a challenge attribute and provide, to the proxy server, the challenge attribute; and
the proxy server to further send, to the access point device, an authentication challenge comprising the challenge attribute.

13. The system of claim 12, wherein:
the proxy server to further send, to the authentication server, a challenge response corresponding to the challenge attribute; and
the authentication server to, responsive to the challenge response, authenticate the user device.

14. The system of claim 12, wherein the proxy server to further:
receive, from the authentication server and in association with the authentication challenge, data representing a URL path corresponding to a resource associated with an authentication session; and
responsive to receiving a response by the user device to the authentication challenge, send, to the URL path, an application programming interface (API) call comprising data representing the response by the user device to the authentication challenge.

15. The system of claim 10, wherein:
the authentication services standard specifies a set of enumerated strings corresponding to enumerated authentication services associated with the authentication services standard; and
the proxy server to further send, to the authentication server, an application programming interface (API) call comprising data representing a non-enumerated string not in the set of enumerated strings and representing the authentication method.

16. The system of claim 10, wherein:
the authentication method comprises an Extensible Authorization Protocol-Authentication and Key Agreement (EAP-AKA) authentication method; and
the authentication services standard supports an EAP-AKA prime authentication method.

17. A non-transitory storage medium to store hardware processor-readable instructions that, when executed by a hardware processor, cause a proxy server to:
determine that a user device specifies a first non-mobile network authentication method;
send, to an authentication path of a Uniform Resource Locator (URL) corresponding to a mobile network-based authentication server, an authentication request to initiate an authentication session corresponding to the user device, wherein the authentication server is associated with an authentication services standard associated with a second non-mobile network authentication method, wherein the authentication services standard is not associated with the first non-mobile network authentication method, and wherein the authentication request comprises an authentication information object to cause the authentication server to apply the first non-mobile network authentication method to provide an authentication challenge;
receive, from the authentication server, the authentication challenge; and
responsive to receiving the authentication challenge, send, to the user device, the authentication challenge.

18. The storage medium of claim 17, wherein:
the authentication services standard specifies a schema defining a generic string type for a set of enumerated authentication services; and
the instructions, when executed by the hardware processor, further cause the proxy server to include a non-enumerated string corresponding to the generic string type in the authentication request.

19. The storage medium of claim 17, wherein:
the authentication services standard specifies a set of enumerated strings corresponding to enumerated authentication services associated with the authentication services standard; and
the instructions that, when executed by the hardware processor, further cause the proxy server to send, to the authentication server, an application programming interface (API) call comprising data representing a non-enumerated string not in the set of enumerated strings and representing the first non-mobile network authentication method.

20. The storage medium of claim 17, wherein the instructions that, when executed by the hardware processor, further cause the proxy server to:
receive, from the authentication server and in association with an authentication challenge, data representing a URL path corresponding to a resource associated with an authentication session; and
responsive to receiving a response by the user device to the authentication challenge, send, to the URL path, an application programming interface (API) call comprising data representing the response by the user device to the authentication challenge.
